(19) United States
(12) Patent Application Publication
(10) Pub. No.: US 2024/0257102 A1
(43) Pub. Date: Aug. 1, 2024

(54) LEARNING METHOD OF DETECTION MODEL FOR DETECTING MISUSED VIRTUAL ASSET TRANSACTION, DETECTION METHOD OF MISUSED VIRTUAL ASSET TRANSACTION USING DETECTION MODEL, AND APPARATUS AND COMPUTER PROGRAM FOR PERFORMING THE SAME

(71) Applicant: KOREA INTERNET & SECURITY AGENCY, Naju-si (KR)

(72) Inventors: Yong Hee SHIN, Naju-si (KR); Keun Woo BAE, Naju-si (KR); Dae II JANG, Naju-si (KR); Seung Goo JI, Naju-si (KR)

(21) Appl. No.: 18/000,384

(22) PCT Filed: Sep. 16, 2022
(86) PCT No.: PCT/KR2022/013886

§ 371 Date: Nov. 30, 2022

(30) Foreign Application Priority Data
Dec. 9, 2021 (KR) 10-2021-0175833

(51) Int. Cl. G06Q 20/36; G06N 20/00

(52) U.S. Cl. CPC G06Q 20/367; G06N 20/00

(57) ABSTRACT

A learning method of a detection model for detecting a misused virtual asset transaction, a detection method of a misused virtual asset transaction using a detection model, and an apparatus and a computer program executing the same according to the exemplary embodiment of the present disclosure learn a machine learning based detection model for detecting a misused virtual asset transaction and detect a misused virtual asset transaction using the detection model which is trained to be built to detect whether a virtual asset wallet address is used for a misused transaction and a misused transaction type before remitting the virtual assets, thereby preventing fraud victims and terrorist financing using virtual assets.

### TECHNICAL FIELD

The present disclosure relates to a learning method of a detection model for detecting a misused virtual asset transaction, a detection method of a misused virtual asset transaction using a detection model, and an apparatus and a computer program for performing the same, and more particularly, to a method, an apparatus, and a computer program for detecting a misused virtual assent transaction.

This study relates to “a cybercrime activity information tracking technology such as a misused virtual asset transaction (No. 1711117111) conducted by the Korea Internet & Security Agency with the support of the Information and Communication Planning and Evaluation Institute with the funding of the Ministry of Science and ICT from 2020 to 2023.

### BACKGROUND ART

The misused virtual asset transaction detection system of the related art simply detects a wallet address which is directly/indirectly connected to a wallet address which is identified as a misused transaction wallet address as a misused transaction wallet address.

### DISCLOSURE

### Technical Problem

An object to be achieved by the present disclosure is to provide a learning method of a detection model for detecting a misused virtual asset transaction, a detection method of a misused virtual asset transaction using a detection model, and an apparatus and a computer program performing the same, which learn a machine learning based detection model for detecting the misused virtual asset transaction and detect the misused virtual asset transaction using the learned and built detection model.

Other and further objects of the present disclosure which are not specifically described can be further considered within the scope easily deduced from the following detailed description and the effect.

### Technical Solution

In order to achieve the above-described technical objects, according to an aspect of the present disclosure, a learning method of a detection model for detecting a misused virtual asset transaction is a learning method performed by an apparatus including a memory which stores one or more programs to learn a detection model for detecting a misused virtual asset transaction and one or more processors which perform an operation for learning the detection model according to one or more programs stored in the memory and the learning method includes: acquiring learning including entire virtual asset block information and feature information corresponding to a misused transaction wallet address acquired based on the misused transaction wallet address identified as a misused virtual asset transaction, by the processor; and learning a machine learning based detection model with the feature information as an input and misused transaction prediction information as an output based on the learning data, by the processor, the acquiring of learning data is configured by acquiring entire transaction information corresponding to the misused transaction wallet address from entire virtual asset block information based on a virtual asset type of the misused transaction wallet address, acquiring the feature information corresponding to the misused transaction wallet address from the entire transaction information based on a feature which is determined in advance for every virtual asset type, among the entire features, and acquiring the learning data for every virtual asset type, and the learning of a detection model is configured by learning the detection model for every virtual asset type, based on the learning data acquired for every virtual asset type.

Here, the acquiring of learning data is configured by acquiring the learning data including feature information corresponding to the misused transaction wallet address and misused transaction type information corresponding to the misused transaction wallet address.

Here, the learning of a detection model is configured by learning the detection model which outputs the misused transaction prediction information including a misused transaction prediction value and a predicted misused transaction type based on the learning data.

Here, the feature information includes first feature information including at least one of information about a number of transactions using a target wallet address for feature extraction, information about a transaction volume of a target wallet address for feature extraction, information about a number of exposures representing the number of times of using a target wallet address for feature extraction in the entire transactions, transaction period information representing an interval between first transaction and a last transaction of target wallet address for feature extraction, information about wallet address type of a target wallet address for feature extraction, information about transaction commission of a target wallet address for feature extraction, and information about a number of wallet addresses representing a number of wallet addresses of the counter party of a target wallet address for feature extraction.

Here, the feature information further includes second feature information which is acquired based on the first feature information and represents statistical values including at least one of a maximum value, a minimum value, a median value, a mean value, a variance value, a skewness value, a kurtosis value, and a standard deviation value.

Here, the acquiring of learning data is configured by acquiring the feature information corresponding to a normal transaction wallet address from the entire virtual asset block information based on the normal transaction wallet address and acquiring the learning data including the feature information corresponding to the misused transaction wallet address and the feature information corresponding to the normal transaction wallet address.

In order to achieve the above-described technical objects, according to an aspect of the present disclosure, an apparatus for learning a detection model for detecting a misused virtual asset transaction is an apparatus for learning a detection model for detecting a misused virtual asset transaction including: a memory which stores one or more programs to learn the detection model; and one or more processors which perform an operation for learning the detection model according to one or more programs stored in the memory. The processor is configured to acquire learning including entire virtual asset block information and feature information corresponding to the misused transaction wallet address acquired based on a misused transaction wallet address identified as misused virtual asset transaction and learn a machine learning based detection model with the feature information as an input and misused transaction prediction information as an output based on the learning data, the processor acquires entire transaction information corresponding to the misused transaction wallet address from entire virtual asset block information based on a virtual asset type of the misused transaction wallet address, acquires the feature information corresponding to the misused transaction wallet address from the entire transaction information based on a feature which is determined in advance for every virtual asset type, among the entire features, acquires the learning data for every virtual asset type, and learns the detection model for every virtual asset type based on the learning data acquired for every virtual asset type.

Here, the feature information includes first feature information including at least one of information about a number of transactions using a target wallet address for feature extraction, information about a transaction volume of a target wallet address for feature extraction, information about a number of exposures representing the number of times of using a target wallet address for feature extraction in the entire transactions, transaction period information representing an interval between first transaction and a last transaction of target wallet address for feature extraction, information about wallet address type of a target wallet address for feature extraction, information about transaction commission of a target wallet address for feature extraction, and information about a number of wallet addresses representing a number of wallet addresses of the counter party of a target wallet address for feature extraction.

Here, the feature information further includes second feature information which is acquired based on the first feature information and represents statistical values including at least one of a maximum value, a minimum value, a median value, a mean value, a variance value, a skewness value, a kurtosis value, and a standard deviation value.

In order to achieve the above-described technical objects, according to an aspect of the present disclosure, a detection method of a misused virtual asset transaction using a detection method is a detection method performed by an apparatus including a memory which stores one or more programs to detect a misused virtual asset transaction using a detection model and one or more processors which perform an operation for detecting a misused virtual asset transaction using the detection model according to one or more programs stored in the memory including: acquiring a detection target wallet address, by the processor; acquiring input data including entire virtual asset block information and feature information corresponding to the detection target wallet address acquired based on the detection target wallet address, by the processor; and acquiring misused transaction detection information corresponding to the detection target wallet address based on the input data using the detection model which is trained in advance to be built, by the processor, the detection model is a machine learning based model with the input data as an input and misused transaction prediction information as an output, and the acquiring of input data is configured by acquiring entire transaction information corresponding to the detection target wallet address from the entire virtual asset block information and acquiring the feature information corresponding to the detection target wallet address from the entire transaction information based on a feature which is determined in advance for every virtual asset type, among the entire feature, the acquiring of misused transaction detection information is configured by inputting the input data to the detection model selected based on a virtual asset type of the detection target wallet address among the detection models which are built for every virtual asset type and acquiring the misused transaction detection information based on the misused transaction prediction information which is the output of the detection model.

Here, the acquiring of misused transaction detection information is configured by acquiring the misused transaction detection information based on the misused transaction prediction information including a misused transaction prediction value and a predicted misused transaction type.

Here, the feature information includes first feature information including at least one of information about a number of transactions using a target wallet address for feature extraction, information about a transaction volume of a target wallet address for feature extraction, information about a number of exposures representing the number of times of using a target wallet address for feature extraction in the entire transactions, transaction period information representing an interval between first transaction and a last transaction of target wallet address for feature extraction, information about wallet address type of a target wallet address for feature extraction, information about transaction commission of a target wallet address for feature extraction, and information about a number of wallet addresses representing a number of wallet addresses of the counter party of a target wallet address for feature extraction.

Here, the feature information further includes second feature information which is acquired based on the first feature information and represents statistical values including at least one of a maximum value, a minimum value, a median value, a mean value, a variance value, a skewness value, a kurtosis value, and a standard deviation value.

In order to achieve the above-described technical objects, according to an aspect of the present disclosure, an apparatus for detecting a misused virtual asset transaction using a detection model is an apparatus for detecting a misused virtual asset transaction using a detection model including: a memory which stores one or more programs to detect a misused virtual asset transaction using a detection model; and one or more processors which perform an operation for detecting a misused virtual asset transaction using the detection model according to one or more programs stored in the memory, the processor is configured to acquire a detection target wallet address, acquire input data including entire virtual asset block information and feature information corresponding to the detection target wallet address acquired based on the detection target wallet address, and acquire misused transaction detection information corresponding to the detection target wallet address based on the input data using the detection model which is trained in advance to be built, the detection model is a machine learning based model with the input data as an input and misused transaction prediction information as an output, and the processor acquires entire transaction information corresponding to the detection target wallet address from the entire virtual asset block information and acquires the feature information corresponding to the detection target wallet address from the entire transaction information based on a feature which is determined in advance for every virtual asset type, among the entire feature, inputs the input data to the detection model selected based on a virtual asset type of the detection target wallet address among the detection models which are built for every virtual asset type and acquires the misused transaction detection information based on the misused transaction prediction information which is the output of the detection model.

Here, the feature information includes first feature information including at least one of information about a number of transactions using a target wallet address for feature extraction, information about a transaction volume of a target wallet address for feature extraction, information about a number of exposures representing the number of times of using a target wallet address for feature extraction in the entire transactions, transaction period information representing an interval between first transaction and a last transaction of target wallet address for feature extraction, information about wallet address type of a target wallet address for feature extraction, information about transaction commission of a target wallet address for feature extraction, and information about a number of wallet addresses representing a number of wallet addresses of the counter party of a target wallet address for feature extraction.

Here, the feature information further includes second feature information which is acquired based on the first feature information and represents statistical values including at least one of a maximum value, a minimum value, a median value, a mean value, a variance value, a skewness value, a kurtosis value, and a standard deviation value.

### Advantageous Effects

According to a learning method of a detection model for detecting a misused virtual asset transaction, a detection method of a misused virtual asset transaction using a detection model, and an apparatus and a computer program executing the same according to the exemplary embodiment of the present disclosure, a machine learning based detection model for detecting a misused virtual asset transaction is learned and a misused virtual asset transaction is detected using the detection model which is trained to be built to detect whether a virtual asset wallet address is used for a misused transaction and a misused transaction type before remitting the virtual assets, thereby preventing fraud victims and terrorist financing using virtual assets.

The effects of the present invention are not limited to the technical effects mentioned above, and other effects which are not mentioned can be clearly understood by those skilled in the art from the following description

### DESCRIPTION OF DRAWINGS

FIG. 1 is a block diagram for explaining an apparatus for detecting a misused virtual asset transaction according to an exemplary embodiment of the present disclosure.

FIG. 2 is a flowchart for explaining a learning method of a detection model for detecting a misused virtual asset transaction according to an exemplary embodiment of the present disclosure.

FIG. 3 is a view for explaining a step of acquiring learning data illustrated in FIG. 2.

FIG. 4 is a view for explaining a process of acquiring feature information illustrated in FIG. 3.

FIG. 5 is a view for explaining a detection model learning step illustrated in FIG. 2.

FIG. 6 is a view for explaining an example of a detection model illustrated in FIG. 5.

FIG. 7 is a view for explaining a first example of a learning method of a detection model for detecting a misused virtual asset according to an exemplary embodiment of the present disclosure to illustrate a learning data acquiring process.

FIG. 8 is a view for explaining a first example of a learning method of a detection model for detecting a misused virtual asset according to an exemplary embodiment of the present disclosure to illustrate a detection model learning process.

FIG. 9 is a view for explaining a second example of a learning method of a detection model for detecting a misused virtual asset according to an exemplary embodiment of the present disclosure to illustrate a feature information acquiring process.

FIG. 10 is a view for explaining a second example of a learning method of a detection model for detecting a misused virtual asset according to an exemplary embodiment of the present disclosure to illustrate a learning data acquiring process.

FIG. 11 is a view for explaining a second example of a learning method of a detection model for detecting a misused virtual asset according to an exemplary embodiment of the present disclosure to illustrate a detection model learning process.

FIG. 12 is a view for explaining a third example of a learning method of a detection model for detecting a misused virtual asset according to an exemplary embodiment of the present disclosure to illustrate a learning data acquiring process.

FIG. 13 is a view for explaining a third example of a learning method of a detection model for detecting a misused virtual asset according to an exemplary embodiment of the present disclosure to illustrate a detection model learning process.

FIG. 14 is a view for explaining a fourth example of a learning method of a detection model for detecting a misused virtual asset according to an exemplary embodiment of the present disclosure to illustrate a learning data acquiring process.

FIG. 15 is a view for explaining a fourth example of a learning method of a detection model for detecting a misused virtual asset according to an exemplary embodiment of the present disclosure to illustrate a detection model learning process.

FIG. 16 is a flowchart for explaining a detection method of a misused virtual asset transaction using a detection model according to an exemplary embodiment of the present disclosure.

FIG. 17 is a view for explaining a step of acquiring input data illustrated in FIG. 16.

FIG. 18 is a view for explaining a process of acquiring feature information illustrated in FIG. 17.

FIG. 19 is a view for explaining a misused transaction detection information acquiring step illustrated in FIG. 16.

FIG. 20 is a view for explaining a first example of a detection method of a misused virtual asset transaction using a detection model according to an exemplary embodiment of the present disclosure to illustrate an input data acquiring process.

FIG. 21 is a view for explaining a first example of a detection method of a misused virtual asset transaction using a detection model according to an exemplary embodiment of the present disclosure to illustrate a misused transaction detection information acquiring process.

FIG. 22 is a view for explaining a second example of a detection method of a misused virtual asset transaction using a detection model according to an exemplary embodiment of the present disclosure to illustrate a misused transaction detection information acquiring process.

FIG. 23 is a view for explaining a third example of a detection method of a misused virtual asset transaction using a detection model according to an exemplary embodiment of the present disclosure to illustrate an input data acquiring process.

FIG. 24 is a view for explaining a third example of a detection method of a misused virtual asset transaction using a detection model according to an exemplary embodiment of the present disclosure to illustrate a misused transaction detection information acquiring process.

### BEST MODE

Hereinafter, embodiments of the present disclosure will be described in detail with reference to the accompanying drawings. Advantages and characteristics of the present disclosure and a method of achieving the advantages and characteristics will be clear by referring to exemplary embodiments described below in detail together with the accompanying drawings. However, the present disclosure is not limited to exemplary embodiments disclosed herein but will be implemented in various different forms. The exemplary embodiments are provided by way of example only so that a person of ordinary skilled in the art can fully understand the disclosures of the present invention and the scope of the present invention. Therefore, the present invention will be defined only by the scope of the appended claims. Like reference numerals generally denote like elements throughout the specification.

Unless otherwise defined, all terms (including technical and scientific terms) used in the present specification may be used as the meaning which may be commonly understood by the person with ordinary skill in the art, to which the present invention belongs. It will be further understood that terms defined in commonly used dictionaries should not be interpreted in an idealized or excessive sense unless expressly and specifically defined.

In the specification, the terms “first” or “second” are used to distinguish one component from the other component so that the scope should not be limited by these terms. For example, a first component may also be referred to as a second component and likewise, the second component may also be referred to as the first component.

In the present specification, in each step, numerical symbols (for example, a, b, and c) are used for the convenience of description, but do not explain the order of the steps so that unless the context apparently indicates a specific order, the order may be different from the order described in the specification. That is, the steps may be performed in the order as described or simultaneously, or an opposite order.

In this specification, the terms “have”, “may have”, “include”, or “may include” represent the presence of the characteristic (for example, a numerical value, a function, an operation, or a component such as a part”), but do not exclude the presence of additional characteristic.

Hereinafter, exemplary embodiments of a detection model learning method for detecting a misused virtual asset transaction, a detection method of a misused virtual asset transaction using a detection model, an apparatus performing the same, and a computer program will be described in detail with reference to the accompanying drawings.

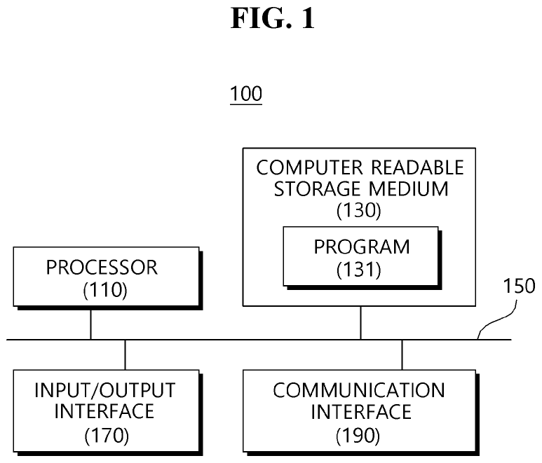

First, an apparatus for detecting a misused virtual asset transaction according to an exemplary embodiment of the present disclosure will be described with reference to FIG. 1.

FIG. 1 is a block diagram for explaining an apparatus for detecting a misused virtual asset transaction according to an exemplary embodiment of the present disclosure.

Referring to FIG. 1, an apparatus 100 for detecting a misused virtual asset transaction according to an exemplary embodiment of the present disclosure may learn a machine learning based detection model for detecting a misused virtual asset transaction. The apparatus 100 detects the misused virtual asset transaction using the trained and built detection model.

By doing this, according to the present disclosure, it is possible to prevent fraud victims and terrorist financing using virtual assets by detecting whether a virtual asset wallet address is used for a misused transaction and a misused transaction type before remitting the virtual assets.

To this end, the apparatus 100 may include one or more processors 110, a computer readable storage medium 130, and a communication bus 150.

The processor 110 controls the apparatus 100 to operate. For example, the processor 110 may execute one or more programs 131 stored in the computer readable storage medium 130. One or more programs 131 include one or more computer executable instructions and when the computer executable instruction is executed by the processor 110, the computer executable instruction may be configured to allow the apparatus 100 to learn the detection model for detecting a misused virtual asset transaction and perform an operation for detecting a misused virtual asset transaction using the trained and built detection model.

The computer readable storage medium 130 is configured to learn the detection model for detecting a misused virtual asset transaction and store a computer executable instruction or program code, program data and/or other appropriate format of information using the trained and built detection model for detecting a misused virtual asset transaction. The program 131 stored in the computer readable storage medium 130 includes a set of instructions executable by the processor 110. In one exemplary embodiment, the computer readable storage medium 130 may be a memory (a volatile memory such as a random access memory, a non-volatile memory, or an appropriate combination thereof), one or more magnetic disk storage devices, optical disk storage devices, flash memory devices, and another format of storage mediums which is accessed by the apparatus 100 and stores desired information, or an appropriate combination thereof.

The communication bus 150 interconnects various other components of the apparatus 100 including the processor 110 and the computer readable storage medium 130 to each other.

The apparatus 100 may include one or more input/output interfaces 170 and one or more communication interfaces 190 which provide an interface for one or more input/output devices. The input/output interface 170 and the communication interface 190 are connected to the communication bus 150. The input/output device (not illustrated) may be connected to the other components of the apparatus 100 by means of the input/output interface 170.

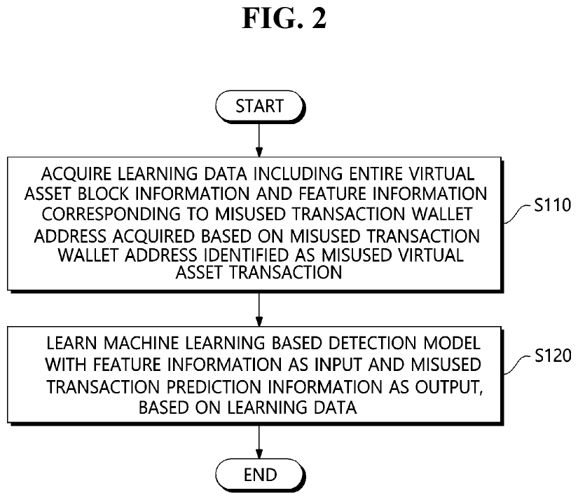

Now, the learning method of a detection model for detecting a misused virtual asset transaction according to an exemplary embodiment of the present disclosure will be described with reference to FIGS. 2 to 15.

### Learning Method for Detection Model

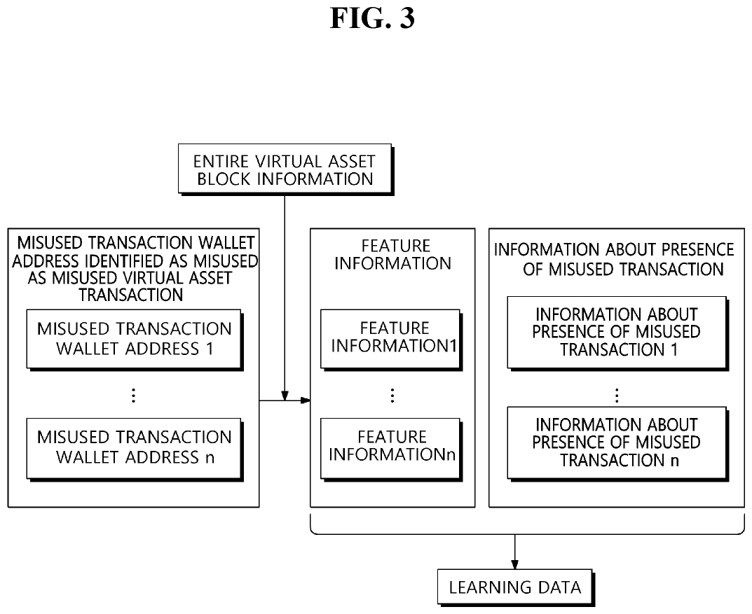

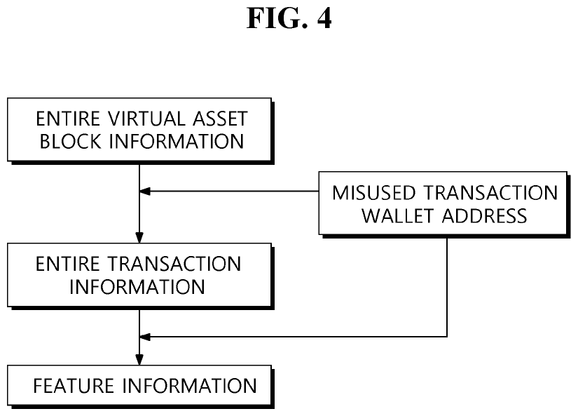

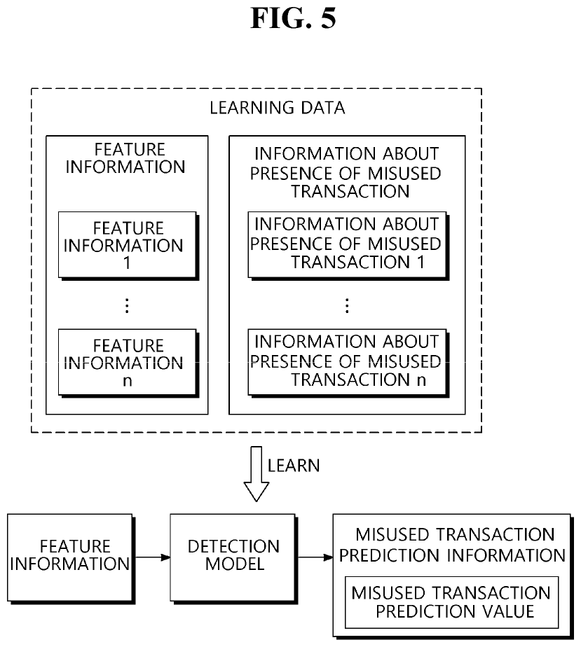

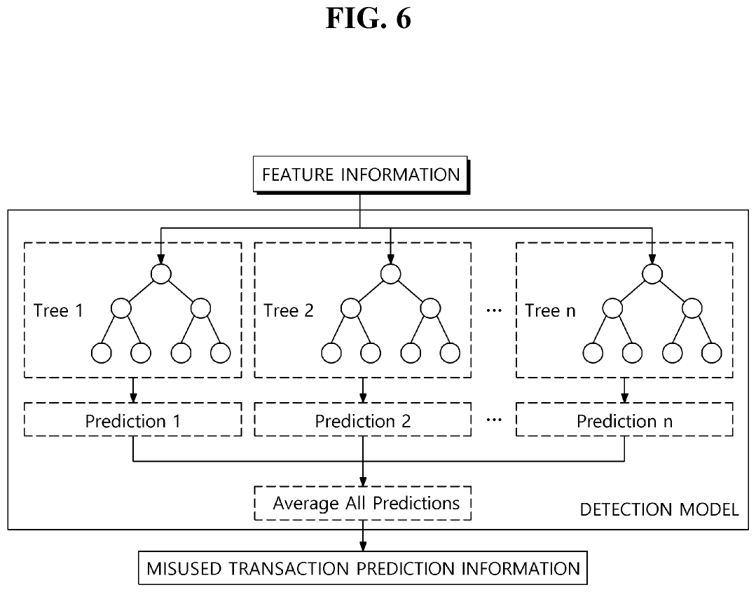

FIG. 2 is a flowchart for explaining a learning method of a detection model for detecting a misused virtual asset transaction according to an exemplary embodiment of the present disclosure, FIG. 3 is a view for explaining a step of acquiring learning data illustrated in FIG. 2, FIG. 4 is a view for explaining a process of acquiring feature information illustrated in FIG. 3, FIG. 5 is a view for explaining a detection model learning step illustrated in FIG. 2, and FIG. 6 is a view for explaining an example of a detection model illustrated in FIG. 5.

Referring to FIG. 2, the processor 110 of the apparatus 100 may acquire learning data including entire virtual asset block information and feature information corresponding to a misused transaction wallet address acquired based on a misused transaction wallet address identified as a misused virtual asset transaction in step S110.

Here, the entire virtual asset block information refers to entire information related to the transaction of virtual assets stored based on a block chain, such as bitcoins or ethereum. One block of the blockchain is configured by data such as “magic number”, “block size”, “block header”, “total number of transaction details”, and “transaction history” and “the transaction history” includes a plurality of unique transactions. Blocks are connected from genesis block to a current block in the form of chains to be called a blockchain.

At this time, the processor 110 collects entire block information of a virtual asset from a transaction network of a virtual asset (bitcoin or ethereum) and stores the collected entire virtual asset block information to be separated for every virtual asset type.

To be more specific, the processor 110 may acquire feature information for each of the plurality of misused transaction wallet addresses which is identified as a misused virtual asset transaction to be stored in advance.

Here, the feature information is a feature related to a target wallet address for feature extraction which is a virtual asset wallet address from which feature information is to be extracted and refers to information extracted from the entire virtual asset blocks.

That is, the feature information includes first feature information including at least one of information about a number of transactions using a target wallet address for feature extraction, information about a transaction volume of a target wallet address for feature extraction, information about a number of exposures representing the number of times of using a target wallet address for feature extraction in the entire transactions, transaction period information representing an interval between a first transaction and a last transaction of a target wallet address for feature extraction, information about a wallet address type of a target wallet address for feature extraction, information about a transaction fee of a target wallet address for feature extraction, and information about a number of wallet addresses representing a number of wallet addresses of the counter party of a target wallet address for feature extraction. For example, the first feature information may be formed of features represented in Table 1. The first feature information may include all or a part of detailed features corresponding to feature types of the first feature 5 information.

TABLE 1

| Feature type of | |
|---|---|
| first feature | |
| information | Detailed feature |
| Information | Number of transactions in which target wallet address |
| about number | for feature extraction is used as transmission address |
| of transactions | Number of transactions in which target wallet address |
| | for feature extraction is used as reception address |
| | Number of transactions in which target wallet address |
| | for feature extraction is used as transmission address or |
| | reception address |
| Information | Amount of virtual assets traded when target wallet |
| about transaction | address for feature extraction is transmission address |
| volume | Total of virtual assets traded when target wallet |
| | address for feature extraction is transmission address |
| | Amount of virtual assets traded when target wallet |
| | address for feature extraction is reception address |
| | Total of virtual assets traded when target wallet |
| | address for feature extraction is reception address |
| | Total of virtual assets traded when target wallet |
| | address for feature extraction is transmission address or |
| | reception address |
| Information | Number of times of being used for transaction when |
| about number | target wallet address for feature extraction is |
| of exposures | transmission address |
| | Number of times of being used for transaction when |
| | target wallet address for feature extraction is reception |
| | address |
| | Number of times of being used for transaction when |
| | target wallet address for feature extraction is |
| | transmission address or reception address |
| Information | Transaction time when target wallet address for |
| about transaction | feature extraction is transmission address |
| period | Interval between transaction when target wallet |
| | address for feature extraction is first transmission |
| | address and transaction when target wallet address for |
| | feature extraction is last transmission address |
| | Transaction time when target wallet address for |
| | feature extraction is reception address |
| | Interval between transaction when target wallet |
| | address for feature extraction is first reception address |
| | and transaction when target wallet address for feature |
| | extraction is last reception address |
| | Interval between first transaction and last transaction |
| | of target wallet address for feature extraction |
| Information | Type of target wallet address for feature extraction |
| about wallet | with first character starting with “1” |
| address type | Type of target wallet address for feature extraction |
| | with first character starting with “3” |
| | Type of target wallet address for feature extraction |
| | with first character starting with “bc1” |
| Information | Transaction fee of target wallet address for feature |
| about | extraction |
| transaction fee | |
| Information | Total number of wallet addresses at which virtual asset |
| about number | is transmitted to target wallet address for feature |
| of wallet | extraction |
| addresses | Total number of wallet addresses at which virtual asset |
| | is received from target wallet address for feature |
| | extraction |

Further, the feature information may further include second feature information which is acquired based on the first feature information and represents statistical values including at least one of a maximum value, a minimum value, a median value, a mean value, a variance value, a skewness value, a kurtosis value, and a standard deviation value. For example, the second feature information may be formed of features represented in Table 2. The first feature information may include all or a part of detailed features corresponding to feature types of the second feature information.

TABLE 2

| Feature type | |
|---|---|
| of second | |
| feature | |
| information | Detailed feature |
| Maximum | Maximum value of information about number of |
| value | transactions |
| | Maximum value of information of transaction volume |
| | Maximum value of information about number of |
| | exposures |
| | Maximum value of information of transaction period |
| | Maximum value of information of transaction fee |
| | Maximum value of information about number of wallet |
| | addresses |
| Minimum | Minimum value of information about number of |
| value | transactions |
| | Minimum value of information of transaction volume |
| | Minimum value of information about number of |
| | exposures |
| | Minimum value of information of transaction period |
| | Minimum value of information of transaction fee |
| | Minimum value of information about number of wallet |
| | addresses |
| Median | Median value of information about number of |
| value | transactions |
| | Median value of information of transaction volume |
| | Median value of information about number of exposures |
| | Median value of information of transaction period |
| | Median value of information of transaction fee |
| | Median value of information about number of wallet |
| | addresses |
| Mean | Mean value of information about number of transactions |
| value | Mean value of information of transaction volume |
| | Mean value of information about number of exposures |
| | Mean value of information of transaction period |
| | Mean value of information of transaction fee |
| | Mean value of information about number of wallet |
| | addresses |
| Variance | Variance value of information about number of |
| value | transactions |
| | Variance value of information of transaction volume |
| | Variance value of information about number of exposures |
| | Variance value of information of transaction period |
| | Variance value of information of transaction fee |
| | Variance value of information about number of wallet |
| | addresses |
| Skewness | Skewness value of information about number of |
| value | transactions |
| | Skewness value of information of transaction volume |
| | Skewness value of information about number of |
| | exposures |
| | Skewness value of information of transaction period |
| | Skewness value of information of transaction fee |
| | Skewness value of information about number of wallet |
| | addresses |
| Kurtosis | Kurtosis value of information about number of |
| value | transactions |
| | Kurtosis value of information of transaction volume |
| | Kurtosis value of information about number of exposures |
| | Kurtosis value of information of transaction period |
| | Kurtosis value of information of transaction fee |
| | Kurtosis value of information about number of wallet |
| | addresses |
| Standard | Standard deviation value of information about number of |
| deviation | transactions |
| value | Standard deviation value of information of transaction |
| | volume |
| | Standard deviation value of information about number of |
| | exposures |
| | Standard deviation value of information of transaction |
| | period |
| | Standard deviation value of information of transaction fee |
| | Standard deviation value of information about number of |
| | wallet addresses |

For example, the processor 110, as illustrated in FIG. 3, acquires feature information (feature information 1 to feature information n) from each of a plurality of misused transaction wallet addresses (misused transaction wallet address 1 to misused transaction wallet address n). At this time, the processor 110 acquires entire transaction information corresponding to the misused transaction wallet address from the entire virtual asset block information and acquires feature information corresponding to the misused transaction wallet address based on the entire transaction information. For example, as illustrated in FIG. 4, the processor 110 acquires entire transaction information formed of transaction information related to the misused transaction wallet address from the entire virtual asset block information and acquires feature information corresponding to the misused transaction wallet address based on the acquired entire transaction information.

The processor 110 acquires feature information acquired from the plurality of misused transaction wallet addresses and learning data including information about the presence of the misused transaction corresponding thereto.

Here, the information about the presence of a misused transaction refers to information indicating whether the virtual asset wallet address is used for a misused transaction. For example, when the virtual asset wallet address is used for a misused transaction, the information about the presence of a misused transaction has a value of “1” and when the virtual asset wallet address is not used for a misused transaction, the information about the presence of a misused transaction has a value of “0”.

For example, the processor 110, as illustrated in FIG. 3, acquires learning data including feature information (feature information 1 to feature information n) acquired from each of the plurality of misused transaction wallet addresses (misused transaction wallet address 1 to misused transaction wallet address n) and information about the presence of a misused transaction (information about presence of misused transaction 1 to information about presence of misused transaction n) corresponding thereto. Next, the processor 110 learns a machine learning based detection model with feature information as an input and misused transaction prediction information as an output, based on the learning data.

That is, the processor 110, as illustrated in FIG. 5, builds a detection model by repeatedly learning the detection model based on the learning data, with the feature information of the learning data as an input of the detection model and the information about the presence of misused transaction of the learning data as an answer label of the detection model.

Here, the detection model may output a misused transaction prediction information including a misused transaction prediction value. The misused transaction prediction value is a value indicating a likelihood that the virtual asset wallet address is used for a misused transaction and has a value between 0 and 1. The closer the misused transaction prediction value to 1, the higher the likelihood of being used for the misused transaction, and the closer the misused transaction prediction value to 0, the lower the likelihood of being used for the misused transaction.

The detection model may be, as illustrated in FIG. 6, a random forest based model formed by a plurality of trees. That is, the detection model acquires prediction values from the plurality of trees based on the input feature information, acquires a misused transaction prediction value by averaging a plurality of prediction values acquired from the plurality of trees, and outputs the misused transaction prediction information including the misused transaction prediction value.

### Learning Method for Detection Model: First Example

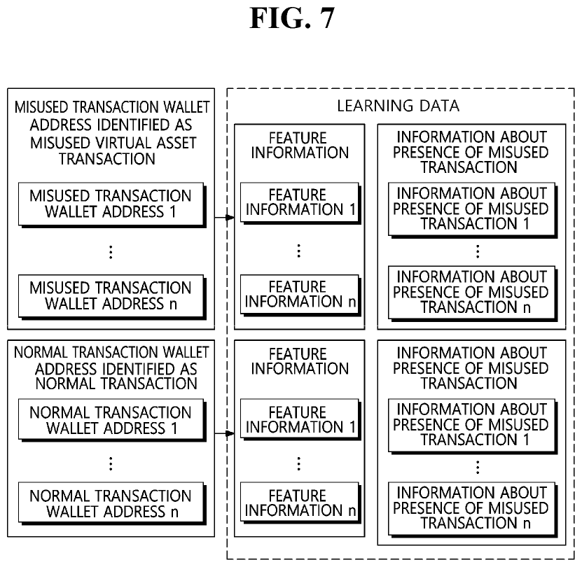

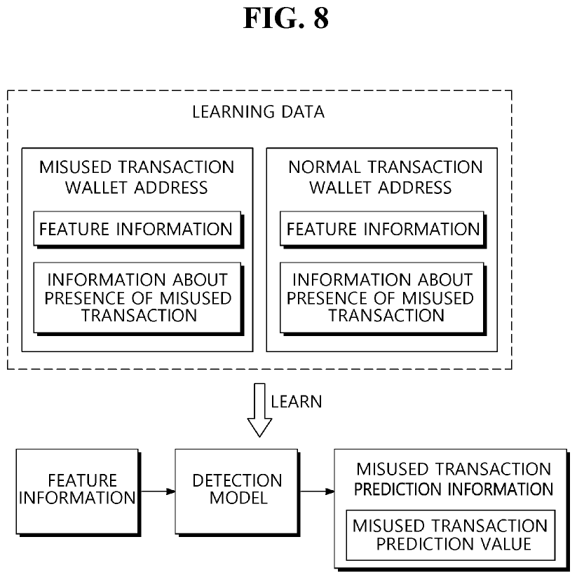

FIG. 7 is a view for explaining a first example of a learning method of a detection model for detecting a misused virtual asset according to an exemplary embodiment of the present disclosure to illustrate a learning data acquiring process and FIG. 8 is a view for explaining a first example of a learning method of a detection model for detecting a misused virtual asset according to an exemplary embodiment of the present disclosure to illustrate a detection model learning process.

Referring to FIGS. 7 and 8, the processor 110 of the apparatus acquires learning data using normal transaction wallet address identified as a normal transaction, as well as a misused transaction wallet address identified as a misused virtual asset.

That is, the processor 110 may acquire feature information for each of the plurality of normal transaction wallet addresses which are identified as a normal virtual asset transaction to be stored in advance.

The processor 110 acquires learning data including feature information corresponding to the misused transaction wallet address and feature information corresponding to the normal transaction wallet address.

Here, the information about the presence of the misused transaction corresponding to the misused transaction wallet address has a value of “1” and the information about the presence of the misused transaction corresponding to the normal transaction wallet address has a value of “0”.

For example, as illustrated in FIG. 7, the processor 110 acquires learning data including feature information (feature information 1 to feature information n) acquired from the plurality of normal transaction wallet addresses (normal transaction wallet address 1 to normal transaction wallet address n) and information about whether there is a misused transaction (information about presence of misused transaction 1 to information about presence of misused transaction n) corresponding thereto, as well as feature information (feature information 1 to feature information n) acquired from each of the plurality of misused transaction wallet addresses (misused transaction wallet address 1 to misused transaction wallet address n) and information about whether there is a misused transaction (information about presence of misused transaction 1 to information about presence of misused transaction n) corresponding thereto.

The processor 110, as illustrated in FIG. 5, learns a detection model with the feature information of the misused transaction wallet address and the feature information about the normal transaction wallet address included in the learning data as an input of the detection model and the information about the presence of misused transaction for the misused transaction wallet address and the information about the presence of misused transaction for the normal transaction wallet address included in the learning data as an answer label of the detection model.

### Learning Method for Detection Model: Second Example

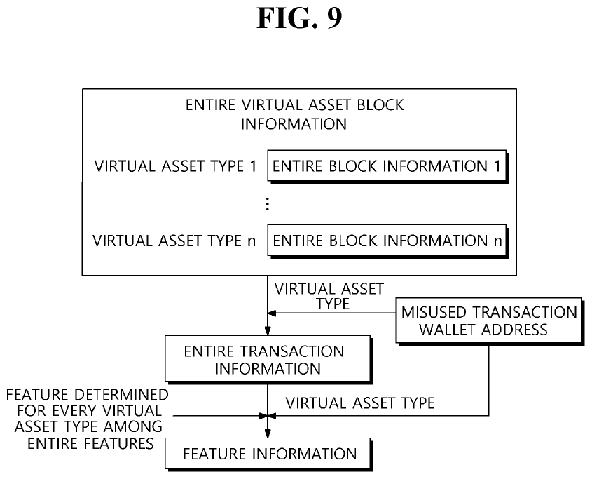

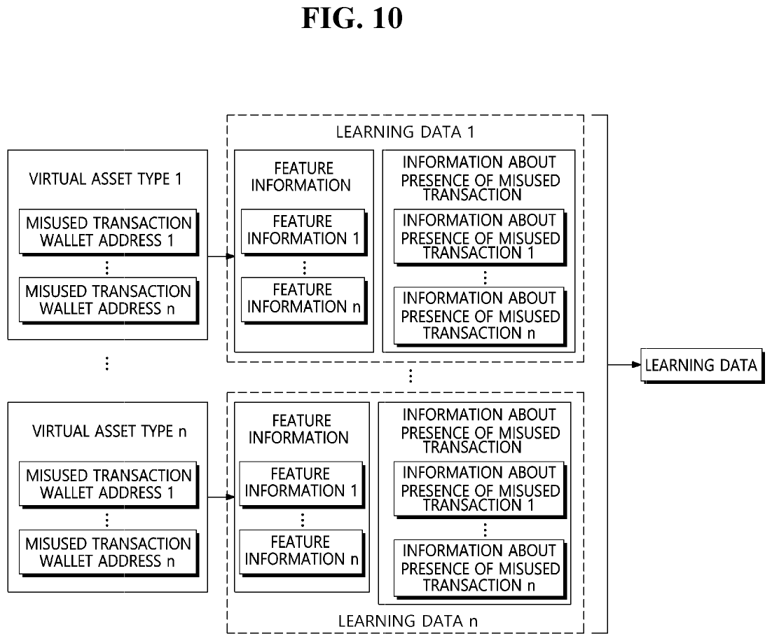

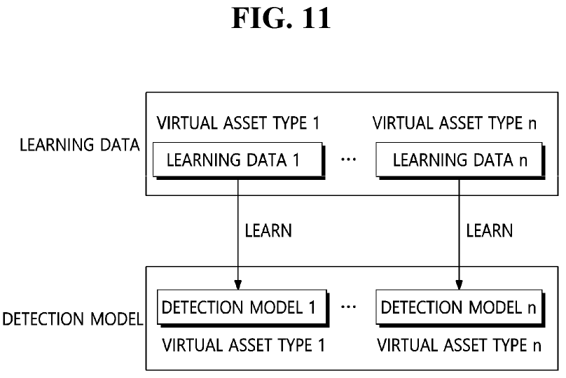

FIG. 9 is a view for explaining a second example of a learning method of a detection model for detecting a misused virtual asset according to an exemplary embodiment of the present disclosure to illustrate a feature information acquiring process. FIG. 10 is a view for explaining a second example of a learning method of a detection model for detecting a misused virtual asset according to an exemplary embodiment of the present disclosure to illustrate a learning data acquiring process. FIG. 11 is a view for explaining a second example of a learning method of a detection model for detecting a misused virtual asset according to an exemplary embodiment of the present disclosure to illustrate a detection model learning process;

Referring to FIGS. 9 to 11, the processor 110 of the apparatus 100 acquires the entire transaction information corresponding to the misused transaction wallet address based on a virtual asset type of the misused transaction wallet address from the entire virtual asset block information in which entire block information is classified according to the virtual asset types.

Here, the virtual asset type refers to a type of the virtual assets such as bitcoin or ethereum.

The processor 110 acquires feature information corresponding to the misused transaction wallet address from the entire transaction information corresponding to the misused transaction wallet address, based on a feature which is determined in advance for every virtual asset type, among the entire features.

For example, the processor 110 acquires the feature information corresponding to the misused transaction wallet address based on a virtual asset type of the misused transaction wallet address using predetermined feature extraction reference information as represented in Tables 3 and 4, among the entire features according to the first feature information of Table 1 and the second feature information of Table 2. Table 3 represents an example of the feature used for a virtual asset type “bitcoin” and Table 4 represents an example of the feature used for a virtual asset type “ethereum”.

TABLE 3

| Feature of “bitcoin” | | Detailed feature |
|---|---|---|
| First | Information | Number of transactions in which target wallet |
| feature | of number | address for feature extraction is used as |
| infor- | of | transmission address |
| mation | transaction | Number of transactions in which target wallet |
| | | address for feature extraction is used as |
| | | reception address |
| | | Number of transactions in which target wallet |
| | | address for feature extraction is used as |
| | | transmission address or reception address |
| | Information | Amount of virtual assets traded when target |
| | about | wallet address for feature extraction is |
| | transaction | transmission address |
| | volume | Total of virtual assets traded when target wallet |
| | | address for feature extraction is transmission |
| | | address |
| | | Amount of virtual assets traded when a target |
| | | wallet address for feature extraction is reception |
| | | address |
| | | Total of virtual assets traded when a target |
| | | wallet address for feature extraction is reception |
| | | address |
| | | Total of virtual assets traded when target wallet |
| | | address for feature extraction is transmission |
| | | address or reception address |
| | Information | Number of times of being used for transaction |
| | about | when target wallet address for feature extraction |
| | number of | is transmission address |
| | exposures | Number of times of being used for transaction |
| | | when target wallet address for feature extraction |
| | | is reception address |
| | | Number of times of being used for transaction |
| | | when target wallet address for feature extraction |
| | | is transmission address or reception address |
| | Information | Interval between transaction when target |
| | about | wallet address for feature extraction is first |
| | transaction | transmission address and transaction when |
| | period | target wallet address for feature extraction is last |
| | | transmission address |
| | | Interval between transaction when target |
| | | wallet address for feature extraction is first |
| | | reception address and transaction when target |
| | | wallet address for feature extraction is last |
| | | reception address |
| | | Interval between first transaction and last |
| | | transaction of target wallet address for feature |
| | | extraction |
| | Information | Type of target wallet address for feature |
| | about | extraction with first character starting with “1” |
| | wallet | Type of target wallet address for feature |
| | address | extraction with first character starting with “3” |
| | type | Type of target wallet address for feature |
| | | extraction with first character starting with |
| | | “bc1” |
| Second | Maximum | Maximum value of information of transaction |
| feature | value | volume |
| infor- | Minimum | Minimum value of information of transaction |
| mation | value | volume |
| | Median | Median value of information of transaction |
| | value | volume |
| | | Median value of information about number of |
| | | exposures |
| | Mean | Mean value of information of transaction |
| | value | volume |
| | | Mean value of information about number of |
| | | exposures |
| | Variance | Variance value of information of transaction |
| | value | volume |
| | | Variance value of information about number of |
| | | exposures |
| | Skewness | Skewness value of information of transaction |
| | value | volume |
| | | Skewness value of information about number |
| | | of exposures |
| | Kurtosis | Kurtosis value of information of transaction |
| | value | volume |
| | | Kurtosis value of information about number of |
| | | exposures |

TABLE 4

| Feature of “ethereum” | | Detailed feature |
|---|---|---|
| First feature | Information of | Number of transaction in which target wallet |
| information | number of | address for feature extraction is used as |
| | transaction | transmission address |
| | | Number of transaction in which target wallet |
| | | address for feature extraction is used as |
| | | reception address |
| | | Number of transaction in which target wallet |
| | | address for feature extraction is used as |
| | | transmission address or reception address |
| | Information | Total of virtual assets traded when target wallet |
| | about transaction | address for feature extraction is transmission |
| | volume | address |
| | | Amount of virtual assets traded when target |
| | | wallet address for feature extraction is reception |
| | | address |
| | | Total of virtual assets traded when target wallet |
| | | address for feature extraction is a reception |
| | | address |
| | | Total of virtual assets traded when target wallet |
| | | address for feature extraction is transmission |
| | | address or reception address |
| | Information | Transaction fee of target wallet address for |
| | about transaction | feature extraction |
| | fee | |
| | Information about | Transaction time when target wallet address |
| | transaction period | for feature extraction is transmission address |
| | | Interval between transaction when target |
| | | wallet address for feature extraction is first |
| | | transmission address and transaction when |
| | | target wallet address for feature extraction is last |
| | | transmission address |
| | | Transaction time when target wallet address |
| | | for feature extraction is reception address |
| | | Interval between transaction when target |
| | | wallet address for feature extraction is first |
| | | reception address and transaction when target |
| | | wallet address for feature extraction is last |
| | | reception address |
| | | Interval between first transaction and last |
| | | transaction of target wallet address for feature |
| | | extraction |
| | Information about | Total number of wallet addresses which |
| | number of wallet | transmit virtual assets to target wallet address |
| | addresses | for feature extraction |
| | | Total number of wallet addresses which |
| | | receive virtual assets from target wallet address |
| | | for feature extraction |
| Second | Maximum value | Maximum value of information of transaction |
| feature | | volume |
| information | | Maximum value of information of transaction |
| | | fee |
| | | Maximum value of information of transaction |
| | | period |
| | Minimum value | Minimum value of information of transaction |
| | | volume |
| | | Minimum value of information of transaction |
| | | fee |
| | | Minimum value of information of transaction |
| | | period |
| | Mean value | Mean value of information of transaction |
| | | volume |
| | | Mean value of information of transaction fee |
| | | Mean value of information of transaction |
| | | period |
| | Standard deviation | Standard deviation value of information of |
| | value | transaction volume |
| | | Standard deviation value of information of |
| | | transaction fee |
| | | Standard deviation value of information of |
| | | transaction period |

The processor 110 performs the process of acquiring feature information corresponding to the misused transaction wallet address for every virtual asset type to acquire learning data for every virtual asset type as illustrated in FIG. 10. The processor 110 may learn the detection model for every virtual asset type based on the learning data acquired for every virtual asset type. For example, as illustrated in FIG. 11, the processor 110 learns a detection model 1 for a virtual asset type 1 based on learning data 1 for the virtual asset type 1 and a detection model n for a virtual asset type n based on learning data n for the virtual asset type n.

### Learning Method for Detection Model: Third Example

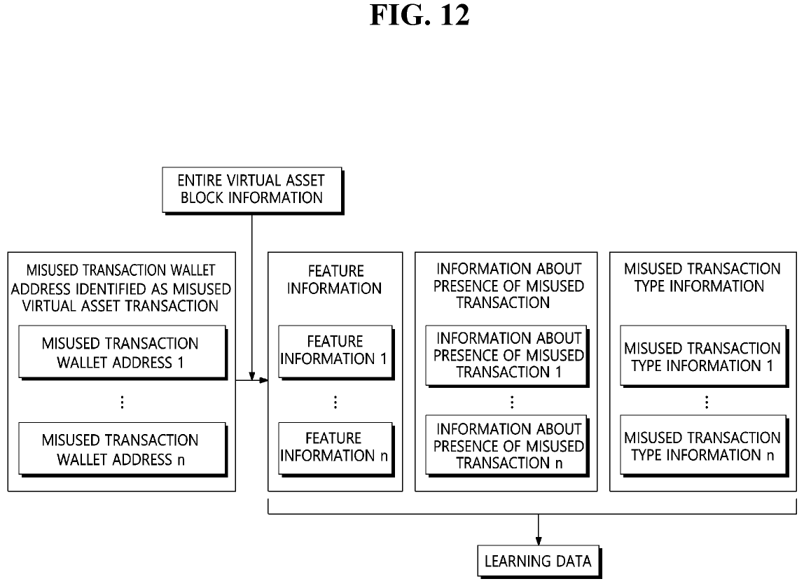

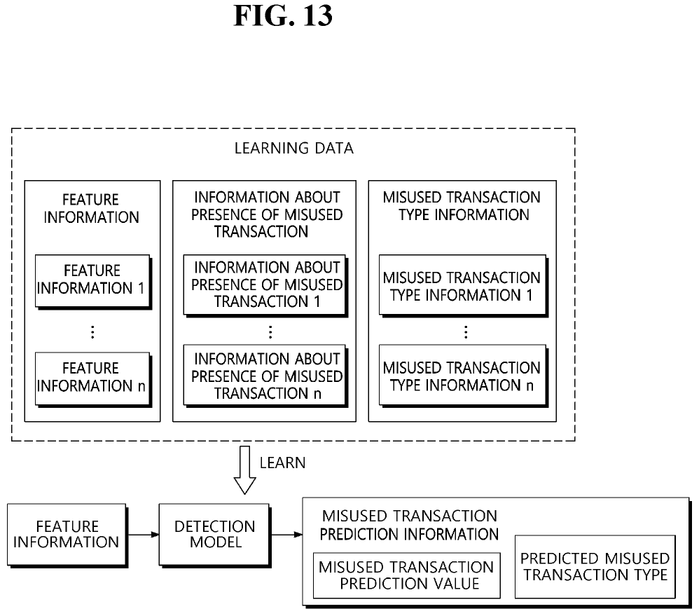

FIG. 12 is a view for explaining a third example of a learning method of a detection model for detecting a misused virtual asset according to an exemplary embodiment of the present disclosure to illustrate a learning data acquiring process. FIG. 13 is a view for explaining a third example of a learning method of a detection model for detecting a misused virtual asset according to an exemplary embodiment of the present disclosure to illustrate a detection model learning process.

Referring to FIGS. 12 and 13, the processor 110 of the apparatus 100 may acquire learning data including misused transaction type information corresponding to the misused transaction wallet address, as well as the feature information corresponding to the misused transaction wallet address and information about the presence of misused transaction corresponding thereto.

Here, the misused transaction type information refers to information indicating a type of misused transaction when the virtual asset wallet address is used for misused transaction. The examples of misused transaction may include investment fraud, malware, illegal transactions, money laundering, and exchange hacking.

The processor 110 learns a detection model with the feature information of the learning data as an input of the detection model and the information about the presence of misused transaction and the misused transaction type information of the learning data as an answer label of the detection model.

Here, the detection model may output a misused transaction prediction information including a misused transaction prediction value and a predicted misused transaction type. The misused transaction type may represent a type of misused transaction which is highly likely to belong to a case that the virtual asset wallet address is used for the misused transaction. The misused transaction type may represent a type of a misused transaction to which the misused transaction of the corresponding virtual asset wallet address is the most likely to belong, among types of various misused transactions.

### Learning Method for Detection Model: Fourth Example

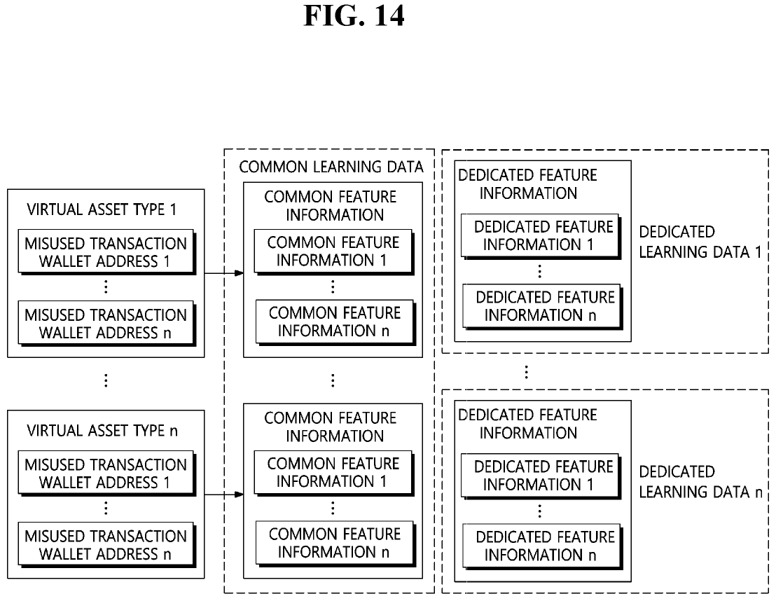

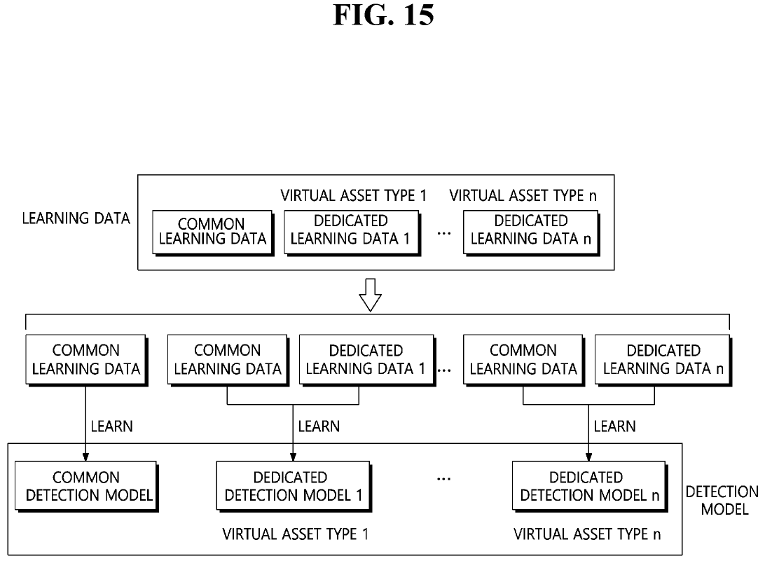

FIG. 14 is a view for explaining a fourth example of a learning method of a detection model for detecting a misused virtual asset according to an exemplary embodiment of the present disclosure to illustrate a learning data acquiring process. FIG. 15 is a view for explaining a fourth example of a learning method of a detection model for detecting a misused virtual asset according to an exemplary embodiment of the present disclosure to illustrate a detection model learning process.

Referring to FIGS. 14 and 15, the processor 110 of the apparatus 100 acquires the feature information corresponding to the misused transaction wallet address by dividing it into common feature information and dedicated feature information, based on a feature which is determined in advance for every virtual asset type among the entire features.

Here, the feature extraction reference information may include information about common feature which is commonly used regardless of the virtual asset type and information about dedicated feature for every virtual asset type representing a feature which is used only for a specific virtual asset, among the entire features.

For example, the processor 110 acquires the common feature information and the dedicated feature information corresponding to the misused transaction wallet address based on a virtual asset type of the misused transaction wallet address using predetermined feature extraction reference information as represented in Table 5, among the entire features according to the first feature information of Table 1 and the second feature information of Table 2.

TABLE 5

| Feature classification | | Detailed feature |
|---|---|---|
| Common feature | | Common feature 1 |
| | | Common feature 2 |
| | | . . . |
| | | Common feature n |
| Dedicated feature | Virtual asset | Type 1-Dedicated feature 1 |
| | type 1 | Type 1-Dedicated feature 2 |
| | | Type 1-Dedicated feature n |
| | . . . | |
| | Virtual asset | Type n-Dedicated feature 1 |
| | type n | Type n-Dedicated feature 2 |
| | | . . . |
| | | Type n-Dedicated feature n |

The processor 110, as illustrated in FIG. 14, acquires common learning data including all the common feature information acquired based on the misused transaction wallet address regardless of the virtual asset type and a plurality of dedicated learning data by dividing the dedicated feature information acquired based on the misused transaction wallet address for every virtual asset type. The processor 110 learns a common detection model which may be used regardless of the virtual asset type based on the common learning data included in the learning data and learns dedicated detection models for every virtual asset type based on dedicated learning data for every virtual asset type included in the learning data. For example, the processor 110, as illustrated in FIG. 15, learns the common detection model using the common learning data, learns a dedicated detection model 1 for the virtual asset type 1 using the common learning data and the dedicated learning data 1, and learns a dedicated detection model n for the virtual asset type n using the common learning data and the dedicated learning data n.

In the meantime, the learning method of the detection model for detecting a misused virtual asset transaction according to the present disclosure may be configured by a learning method according to one of the first example (see FIGS. 7 and 8), the second example (see FIGS. 9 to 11), the third example (see FIGS. 12 and 13), and the fourth example (see FIGS. 14 and 15) or a learning method obtained by combining a plurality of examples among the first to fourth examples.

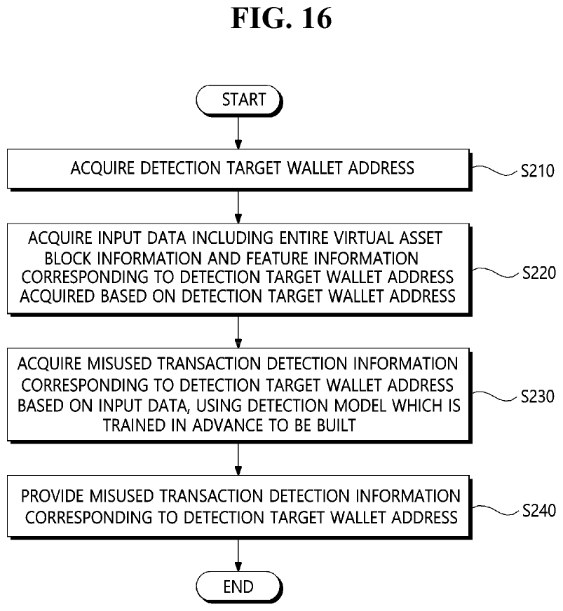

Now, a detection method of a misused virtual asset transaction using the detection model according to the exemplary embodiment of the present disclosure will be described with reference to FIGS. 16 to 24.

### Detection Method Using Detection Model

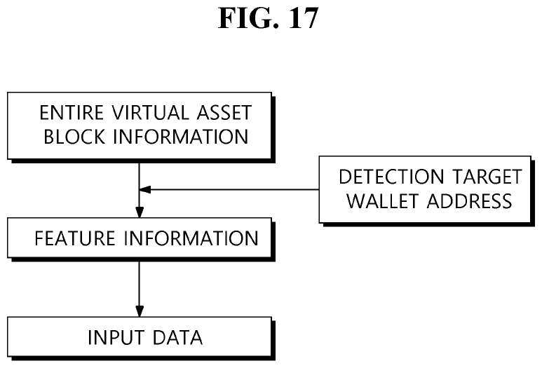

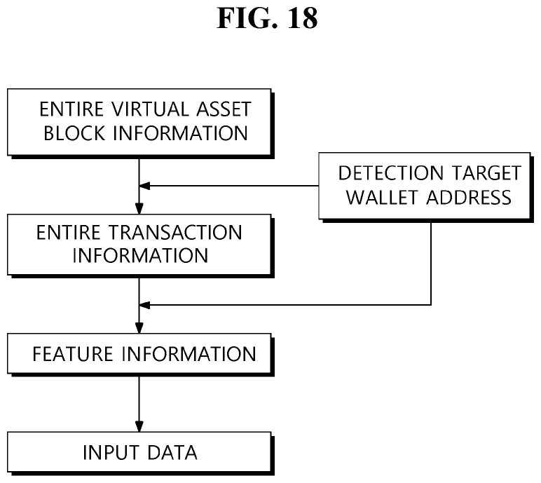

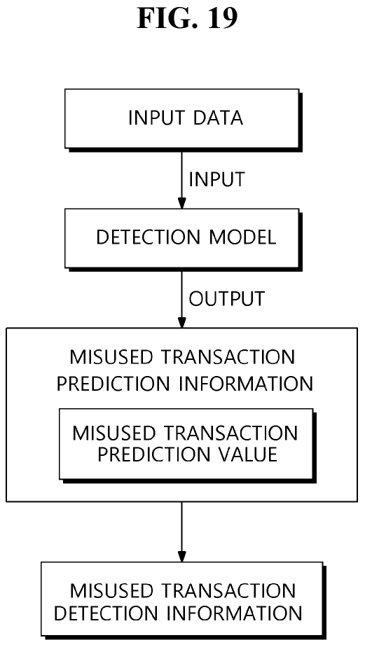

FIG. 16 is a flowchart for explaining a detection method of a misused virtual asset transaction using a detection model according to an exemplary embodiment of the present disclosure. FIG. 17 is a view for explaining a step of acquiring input data illustrated in FIG. 16, FIG. 18 is a view for explaining a process of acquiring feature information illustrated in FIG. 17, and FIG. 19 is a view for explaining a misused transaction detection information acquiring step illustrated in FIG. 16;

Referring to FIG. 16, the processor 110 of the apparatus 100 acquires a detection target wallet address in step S210.

Here, the detection target wallet address may be a virtual asset wallet address provided from a user terminal (not illustrated). For example, a user may request the apparatus 100 according to the present disclosure to detect the misused transaction with a wallet address of the counter party as a detection target wallet address to confirm whether it is the misused transaction of the wallet address of the counter party before dealing the user's virtual asset with a counter party. The detection target wallet address may be a virtual asset wallet address which may be newly opened for transaction of the virtual asset. In this case, the detection target wallet address may be a newly opened wallet address and may be provided from the exchange of the virtual asset.

Next, the processor 110 acquires input data including feature information corresponding to the detection target wallet address acquired based on the entire virtual asset block information and the detection target wallet address in step S220.

To be more specific, the processor 110, as illustrated in FIG. 17, feature information corresponding to the detection target wallet address from the entire virtual asset block information and acquires feature information corresponding to the detection target wallet address based on the entire transaction information.

At this time, the processor 110 acquires entire transaction information corresponding to the detection target wallet address from the entire virtual asset block information and acquires feature information corresponding to the detection target wallet address based on the entire transaction information. For example, as illustrated in FIG. 4, the processor 110 acquires entire transaction information formed of transaction information related to the detection target wallet address from the entire virtual asset block information and acquires feature information corresponding to the detection target wallet address based on the acquired entire transaction information.

The processor 110, as illustrated in FIG. 17, acquires input data including feature information corresponding to the detection target wallet address.

Next, the processor 110 acquires a misused transaction detection information corresponding to the detection target wallet address based on input data using a detection model which is trained in advance to be built in step S230.

Here, the detection model may be a machine learning based model with input data, that is, feature information as an input and misused transaction prediction information including a misused transaction prediction value as an output.

That is, the processor 110, as illustrated in FIG. 19, inputs the input data to the detection model and acquires misused transaction detection information based on the misused transaction prediction information which is an output of the detection model.

At this time, the processor 110 acquires misused transaction detection information based on misused transaction prediction information corresponding to the detection target wallet address, that is, a misused transaction prediction value and a predetermined misused transaction reference value. For example, when the misused transaction reference value is set to “0.7”, if the misused transaction prediction value corresponding to the detection target wallet address is equal to or larger than “0.7”, the processor 110 acquires misused transaction detection information of “high misused transaction possibility” and if the misused transaction prediction value corresponding to the detection target wallet address is lower than “0.7”, the processor 110 acquires misused transaction detection information of “low misused transaction possibility”.

The processor 110 acquires one level according to the misused transaction prediction value corresponding to the detection target wallet address among a plurality of levels according to the misused transaction prediction value and acquires the acquired level as the misused transaction detection information. For example, when the misused transaction prediction value is “0<misused transaction prediction value <0.3”, the level is set to “low misused transaction possibility”, when the misused transaction prediction value is “0.3≤ misused transaction prediction value <0.7”, the level is set to “normal misused transaction possibility”, and when the misused transaction prediction value is “0.7≤misused transaction prediction value ≤1”, the level is set to “high misused transaction possibility”. In this case, the processor 110 identifies the corresponding level based on the misused transaction prediction value corresponding to the detection target wallet address and acquires the identified level as the misused transaction detection information.

The processor may acquire the misused transaction prediction information corresponding to the detection target wallet address, that is, the misused transaction prediction by representing a percentile, as misused transaction detection information. For example, when the misused transaction prediction value corresponding to the detection target wallet address is “0.78”, the processor 110 may acquire “78%” as misused transaction detection information of the detection target wallet address.

Next, the processor 110 provides the misused transaction detection information corresponding to the detection target wallet address in step S240.

For example, when the detection target wallet address is provided from the user terminal, the processor 110 provides the misused transaction detection information corresponding to the detection target wallet address to the user terminal. By doing this, the user may determine whether to continue the transaction with the counter party based on the misused transaction detection information, prior to the transaction of the user's virtual asset with the counter party.

### Detection Method Using Detection Model First Example

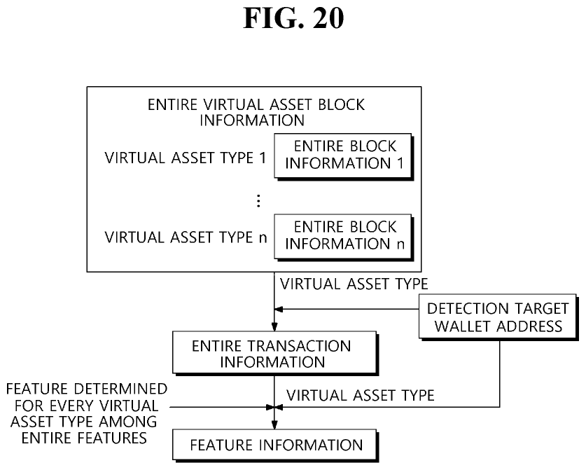

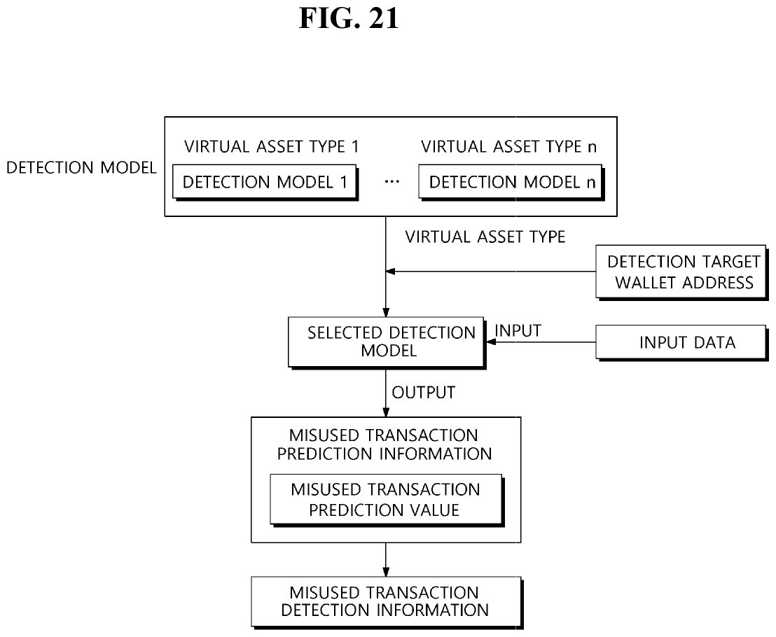

FIG. 20 is a view for explaining a first example of a detection method of a misused virtual asset transaction using a detection model according to an exemplary embodiment of the present disclosure to illustrate an input data acquiring process. FIG. 21 is a view for explaining a first example of a detection method of a misused virtual asset transaction using a detection model according to an exemplary embodiment of the present disclosure to illustrate a misused transaction detection information acquiring process.

Referring to FIGS. 20 and 21, the processor 110 of the apparatus 100 acquires the entire transaction information corresponding to the detection target wallet address based on a virtual asset type of the detection target wallet address from the entire virtual asset block information in which entire block information is classified according to the virtual asset types.

The processor 110 acquires feature information corresponding to the detection target wallet address from the entire transaction information corresponding to the detection target wallet address, based on a feature which is determined in advance for every virtual asset type, among the entire features.

For example, the processor 110 acquires the feature information corresponding to the detection target wallet address based on a virtual asset type of the detection target wallet address using predetermined feature extraction reference information as represented in Tables 3 and 4, among the entire features according to the first feature information of Table 1 and the second feature information of Table 2.

The processor 110, as illustrated in FIG. 21, selects a detection model corresponding to the detection target wallet address based on a virtual asset type of the detection target wallet address from the detection model built for every virtual asset type.

The processor 110, as illustrated in FIG. 21, inputs the input data to the selected detection model and acquires misused transaction detection information based on the misused transaction prediction information which is an output of the selected detection model.

### Detection Method Using Detection Model Second Example

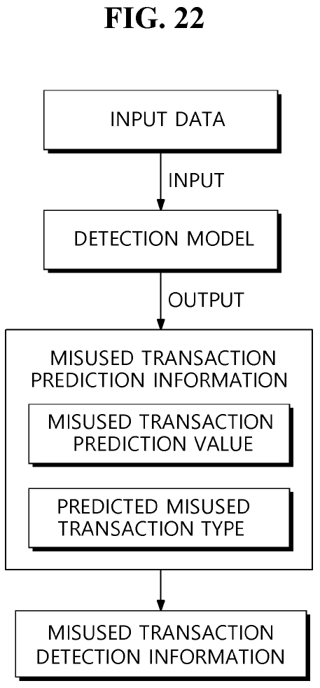

FIG. 22 is a view for explaining a second example of a detection method of a misused virtual asset transaction using a detection model according to an exemplary embodiment of the present disclosure to illustrate a misused transaction detection information acquiring process;

Referring to FIG. 22, the processor 110 of the apparatus 100 inputs input data of the detection target wallet address to the detection model and acquires misused transaction detection information based on misused transaction prediction information which is an output of the detection model.

Here, the misused transaction prediction information may include a misused transaction prediction value and a misused transaction type to be predicted.

That is, the processor 110 may acquire misused transaction detection information further including information about a type of a misused transaction which is highly likely to belong when the misused target wallet address is used for the misused transaction, as well as misused transaction detection information acquired based on the misused transaction prediction value corresponding to the detection target wallet address.

At this time, the processor 110 acquires misused transaction detection information including misused transaction type predicted only when the misused transaction possibility acquired based on the misused transaction prediction value corresponding to the detection target wallet address is equal to or higher than a predetermined reference.

For example, when the misused transaction prediction value corresponding to the detection target wallet address is larger than “0.7” which is a misused transaction reference value or a level according to the misused prediction value is “high misused transaction possibility”, the processor 110 acquires the misused transaction detection information further including information about a type of the misused transaction predicted based on “predicted misused transaction type” which is an output of the detection model”.

### Detection Method Using Detection Model Third Example

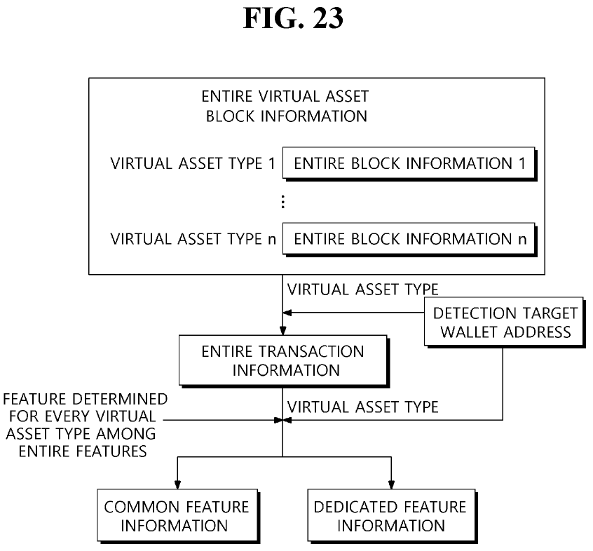

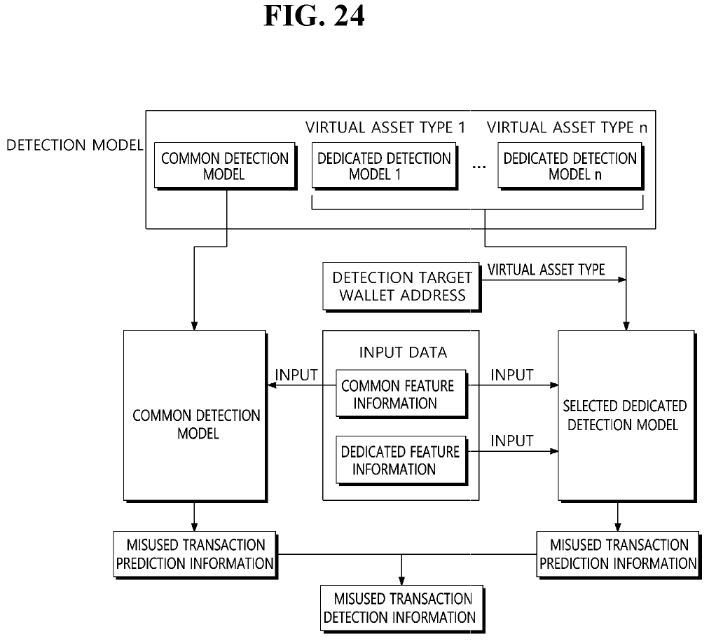

FIG. 23 is a view for explaining a third example of a detection method of a misused virtual asset transaction using a detection model according to an exemplary embodiment of the present disclosure to illustrate an input data acquiring process. FIG. 24 is a view for explaining a third example of a detection method of a misused virtual asset transaction using a detection model according to an exemplary embodiment of the present disclosure to illustrate a misused transaction detection information acquiring process.

Referring to FIGS. 23 and 24, the processor 110 of the apparatus 100 acquires the feature information corresponding to the detection target wallet address by dividing it into common feature information and dedicated feature information, based on predetermined feature extraction reference information.

Here, the feature extraction reference information may include information about common feature which is commonly used regardless of the virtual asset type and information about dedicated feature for every virtual asset type representing a feature which is used only for a specific virtual asset, among the entire features.

For example, the processor 110 acquires the common feature information and the dedicated feature information corresponding to the detection target wallet address based on a virtual asset type of the detection target wallet address using predetermined feature extraction reference information as represented in Table 5, among the entire features according to the first feature information of Table 1 and the second feature information of Table 2.

The processor 110 selects a dedicated detection model corresponding to the detection target wallet address based on a virtual asset type of the detection target wallet address from the dedicated detection model built for every virtual asset type.

The processor 110 inputs common feature information of the input data to a previously built common detection model and acquires misused transaction prediction information which is an output of the common detection model.

The processor 110 inputs common feature information and dedicated feature information of the input data to a selected dedicated detection model and acquires misused transaction prediction information which is an output of the selected dedicated detection model.

The processor 110 acquires misused transaction detection information for the detection target wallet address based on misused transaction prediction information which is an output of the common detection model and misused transaction prediction information which is an output of the selected dedicated detection model.

At this time, the processor 110 acquires a value obtained by averaging a misused transaction prediction value which is an output of the common detection model and a misused transaction prediction value which is an output of the selected dedicated detection model as a final misused transaction prediction value and acquires misused transaction detection information based on the acquired final misused transaction prediction value.

The processor may acquire a value obtained by weighting the misused transaction prediction value which is an output of the common detection model and the misused transaction prediction value which is an output of the selected dedicated detection model as a final misused transaction prediction value corresponding to the detection target wallet address.

The operation according to the exemplary embodiment of the present disclosure may be implemented as a program instruction which may be executed by various computers to be recorded in a computer readable storage medium. The computer readable storage medium indicates an arbitrary medium which participates to provide a command to a processor for execution. The computer readable storage medium may include solely a program command, a data file, and a data structure or a combination thereof. For example, the computer readable medium may include a magnetic medium, an optical recording medium, and a memory. The computer program may be distributed on a networked computer system so that the computer readable code may be stored and executed in a distributed manner. Functional programs, codes, and code segments for implementing the present embodiment may be easily inferred by programmers in the art to which this embodiment belongs.

The present embodiments are provided to explain the technical spirit of the present embodiment and the scope of the technical spirit of the present embodiment is not limited by these embodiments. The protection scope of the present embodiments should be interpreted based on the following appended claims and it should be appreciated that all technical spirits included within a range equivalent thereto are included in the protection scope of the present embodiments.

1. A learning method performed by an apparatus including a memory which stores one or more programs to learn a detection model for detecting a misused virtual asset transaction and one or more processors which perform an operation for learning the detection model according to one or more programs stored in the memory, the learning method comprising:
acquiring learning data including entire virtual asset block information and feature information corresponding to a misused transaction wallet address acquired based on the misused transaction wallet address identified as a misused virtual asset transaction, by the processor; and
learning a machine learning based detection model with the feature information as an input and misused transaction prediction information as an output based on the learning data, by the processor,
wherein the acquiring of learning data is configured by acquiring entire transaction information corresponding to the misused transaction wallet address from entire virtual asset block information based on a virtual asset type of the misused transaction wallet address, acquiring the feature information corresponding to the misused transaction wallet address from the entire transaction information based on a feature which is determined in advance for every virtual asset type, among the entire features, and acquiring the learning data for every virtual asset type, and the learning of a detection model is configured by learning the detection model for every virtual asset type, based on the learning data acquired for every virtual asset type.

2. The learning method of a detection model according to claim 1, wherein the acquiring of learning data is configured by acquiring the learning data including feature information corresponding to the misused transaction wallet address and misused transaction type information corresponding to the misused transaction wallet address.

3. The learning method of a detection model according to claim 2, wherein the learning of a detection model is configured by learning the detection model which outputs the misused transaction prediction information including a misused transaction prediction value and a predicted misused transaction type, based on the learning data.

4. The learning method of a detection model according to claim 1, wherein the feature information includes first feature information including at least one of information about a number of transactions using a target wallet address for feature extraction, information about a transaction volume of a target wallet address for feature extraction, information about a number of exposures representing the number of times of using a target wallet address for feature extraction in the entire transactions, transaction period information representing an interval between first transaction and a last transaction of target wallet address for feature extraction, information about wallet address type of a target wallet address for feature extraction, information about transaction commission of a target wallet address for feature extraction, and information about a number of wallet addresses representing a number of wallet addresses of the counter party of a target wallet address for feature extraction.

5. The learning method of a detection model according to claim 4, wherein the feature information further includes second feature information which is acquired based on the first feature information and represents statistical values including at least one of a maximum value, a minimum value, a median value, a mean value, a variance value, a skewness value, a kurtosis value, and a standard deviation value.

6. The learning method of a detection model according to claim 1, wherein the acquiring of learning data is configured by the feature information corresponding to a normal transaction wallet address from the entire virtual asset block information based on the normal transaction wallet address and acquiring the learning data including the feature information corresponding to the misused transaction wallet address and the feature information corresponding to the normal transaction wallet address.

7. An apparatus for learning a detection model for detecting a misused virtual asset transaction, comprising:
a memory which stores one or more programs to learn the detection model; and
one or more processors which perform an operation for learning the detection model according to one or more programs stored in the memory,
wherein the processor is configured to acquire learning including entire virtual asset block information and feature information corresponding to the misused transaction wallet address acquired based on a misused transaction wallet address identified as misused virtual asset transaction and learn a machine learning based detection model with the feature information as an input and misused transaction prediction information as an output based on the learning data, acquire entire transaction information corresponding to the misused transaction wallet address from entire virtual asset block information based on a virtual asset type of the misused transaction wallet address, acquire the feature information corresponding to the misused transaction wallet address from the entire transaction information based on a feature which is determined in advance for every virtual asset type, among the entire features, and acquire the learning data for every virtual asset type, and learn the detection model for every virtual asset type, based on the learning data acquired for every virtual asset type.

8. The apparatus according to claim 7, wherein the feature information includes first feature information including at least one of information about a number of transactions using a target wallet address for feature extraction, information about a transaction volume of a target wallet address for feature extraction, information about a number of exposures representing the number of times of using a target wallet address for feature extraction in the entire transactions, transaction period information representing an interval between first transaction and a last transaction of target wallet address for feature extraction, information about wallet address type of a target wallet address for feature extraction, information about transaction commission of a target wallet address for feature extraction, and information about a number of wallet addresses representing a number of wallet addresses of the counter party of a target wallet address for feature extraction.

9. The apparatus according to claim 8, wherein the feature information further includes second feature information which is acquired based on the first feature information and represents statistical values including at least one of a maximum value, a minimum value, a median value, a mean value, a variance value, a skewness value, a kurtosis value, and a standard deviation value.

10. A detection method performed by an apparatus including a memory which stores one or more programs to detect a misused virtual asset transaction using a detection model and one or more processors which perform an operation for detecting a misused virtual asset transaction using the detection model according to one or more programs stored in the memory, the detection method comprising:
acquiring a detection target wallet address, by the processor;
acquiring input data including entire virtual asset block information and feature information corresponding to the detection target wallet address acquired based on the detection target wallet address, by the processor; and
acquiring misused transaction detection information corresponding to the detection target wallet address based on the input data using the detection model which is trained in advance to be built, by the processor,
wherein the detection model is a machine learning based model with the input data as an input and misused transaction prediction information as an output,
the acquiring of input data is configured by acquiring entire transaction information corresponding to the detection target wallet address from the entire virtual asset block information and acquiring the feature information corresponding to the detection target wallet address from the entire transaction information based on a feature which is determined in advance for every virtual asset type, among the entire feature, and
the acquiring of misused transaction detection information is configured by inputting the input data to the detection model selected based on a virtual asset type of the detection target wallet address among the detection models which are built for every virtual asset type and acquiring the misused transaction detection information based on the misused transaction prediction information which is the output of the detection model.

11. The detection method according to claim 10, wherein the acquiring of misused transaction detection information is configured by acquiring the misused transaction detection information based on the misused transaction prediction information including a misused transaction prediction value and a predicted misused transaction type.

12. The detection method according to claim 10, wherein the feature information includes first feature information including at least one of information about a number of transactions using a target wallet address for feature extraction, information about a transaction volume of a target wallet address for feature extraction, information about a number of exposures representing the number of times of using a target wallet address for feature extraction in the entire transactions, transaction period information representing an interval between first transaction and a last transaction of target wallet address for feature extraction, information about wallet address type of a target wallet address for feature extraction, information about transaction commission of a target wallet address for feature extraction, and information about a number of wallet addresses representing a number of wallet addresses of the counter party of a target wallet address for feature extraction.

13. The detection method according to claim 12, wherein the feature information further includes second feature information which is acquired based on the first feature information and represents statistical values including at least one of a maximum value, a minimum value, a median value, a mean value, a variance value, a skewness value, a kurtosis value, and a standard deviation value.

14. An apparatus for detecting a misused virtual asset transaction using a detection model, comprising:
a memory which stores one or more programs to detect a misused virtual asset transaction using a detection model; and
one or more processors which perform an operation for detecting a misused virtual asset transaction using the detection model according to one or more programs stored in the memory,
wherein the processor is configured to acquire a detection target wallet address, acquire input data including entire virtual asset block information and feature information corresponding to the detection target wallet address acquired based on the detection target wallet address, and acquire misused transaction detection information corresponding to the detection target wallet address based on the input data using the detection model which is trained in advance to be built,
the detection model is a machine learning based model with the input data as an input and misused transaction prediction information as an output, and
the processor acquires entire transaction information corresponding to the detection target wallet address from the entire virtual asset block information and acquires the feature information corresponding to the detection target wallet address from the entire transaction information based on a feature which is determined in advance for every virtual asset type, among the entire feature, and inputs the input data to the detection model selected based on a virtual asset type of the detection target wallet address among the detection models which are built for every virtual asset type and acquires the misused transaction detection information based on the misused transaction prediction information which is the output of the detection model.

15. The apparatus according to claim 14, wherein the feature information includes first feature information including at least one of information about a number of transactions using a target wallet address for feature extraction, information about a transaction volume of a target wallet address for feature extraction, information about a number of exposures representing the number of times of using a target wallet address for feature extraction in the entire transactions, transaction period information representing an interval between first transaction and a last transaction of target wallet address for feature extraction, information about wallet address type of a target wallet address for feature extraction, information about transaction commission of a target wallet address for feature extraction, and information about a number of wallet addresses representing a number of wallet addresses of the counter party of a target wallet address for feature extraction.

16. The apparatus according to claim 15, wherein the feature information further includes second feature information which is acquired based on the first feature information and represents statistical values including at least one of a maximum value, a minimum value, a median value, a mean value, a variance value, a skewness value, a kurtosis value, and a standard deviation value.
